(19) United States
(12) Patent Application Publication
(10) Pub. No.: US 2026/0354365 A1
(43) Pub. Date: Nov. 12, 2026

(54) TRAP WITH SELECTIVE BAIT EXPOSURE TYPE TERMITE ERADICATION FUNCTION

(71) Applicants: ETND CO., LTD., Gwangju-si, Gyeonggi-do (KR); KOREA NATIONAL UNIVERSITY OF HERITAGE EDUCATIONAL INDUSTRIAL ASSOCIATION, Chungcheongnam-do (KR)

(72) Inventors: Dong Sik RYU, Seoul (KR); Rong Jin JUNG, Hanam-si, Gyeonggi-do (KR); Yong Jae CHUNG, Chungcheongnam-do (KR)

(73) Assignees: ETND CO., LTD., Gwangju-si, Gyeonggi-do (KR); KOREA NATIONAL UNIVERSITY OF HERITAGE EDUCATIONAL INDUSTRIAL ASSOCIATION, Chungcheongnam-do (KR)

(21) Appl. No.: 19/132,866

(22) PCT Filed: Sep. 19, 2024
(86) PCT No.: PCT/KR2024/014093

§ 371 Date: May 26, 2025

(30) Foreign Application Priority Data
Dec. 6, 2023 (KR) 10-2023-0175397

(51) Int. Cl. A01M 1/02; A01M 1/10; G01V 3/08

(52) U.S. Cl. CPC A01M 1/02; A01M 1/103; G01V 3/08

(57) ABSTRACT

A trap with a selective bait exposure type termite eradication function according to the present disclosure includes: a body that has an accommodation space formed therein and is configured to allow termites to enter and exit; a cover module that is coupled to an upper end of the body to prevent foreign substances from entering the body and simultaneously to prevent termites that have entered the body from freely escaping; and a cartridge module that is provided in the accommodation space, accommodates a bait capable of eradicating termites therein, and is at least partially opened to selectively expose the bait to the termites, wherein the cartridge module is provided with a separate feeding block, and when termites feed on the feeding block beyond a predetermined level, the cartridge module is opened and the bait is exposed to the outside.

### CROSS REFERENCE TO PRIOR APPLICATIONS

This application is a National Stage Application of PCT International Patent Application No. PCT/KR2024/014093 filed on Sep. 19, 2024, under 35 U.S.C. § 371, which claims priority to Korean Patent Application No. 10-2023-0175397 filed on Dec. 6, 2023, which are all hereby incorporated by reference in their entirety.

### ACKNOWLEDGEMENT

Project ID: 2550000020
Project Number: RS-2021-NC100803
Government Agency: Korea Heritage Service
Managing Organization: National Research Institute of Cultural Heritage
Project Title: Development of Smart Preservation and Utilization Technology for Cultural Heritage (R&D)
Research Task Title: Biomarker Detection and Monitoring System Development for the Activity investigation of Termites
Performing Institutions: ETND Co., Ltd. and Korea National University of Heritage Educational Industrial Association
Project Period: Jan. 1, 2025-Dec. 31, 2025

### TECHNICAL FIELD

The present disclosure relates to a trap with a selective bait exposure type termite eradication function, and more particularly, to a trap with a selective bait exposure type termite eradication function, which confirms the presence or absence of termites in a monitoring area and simultaneously performs termite eradication to enable prompt response.

### BACKGROUND ART

In general, it is known that around 2,050 species of termites live on Earth, and the termite living in Korea is the Kyushu termite, which is about 2.3 mm in body length, and the Kyushu termite is known to live in colonies of around 10,000 to 100,000 termites.

Termites are social insects, and the king termite, queen termite, soldier termite, and worker termite live in groups and form colonies.

The worker termite makes up the majority of termites, and it is known to search for food, bring it back, feed the larvae and soldier termites, take care of the young termites, clean the nest, repair the nest when it is damaged, and build a new nest when relocation is necessary.

Termites mostly eat up wood and leaves, as well as dead wood and fallen leaves, and they absorb glucose for nutrition by breaking down fiber and excrete waste that contains various organic matter and salts.

In this way, termites clean up wood and fallen leaves, and because their waste helps plants grow, they are indispensable insects in the ecosystem and play an important role in linking predators and producers in the ecological cycle.

However, important cultural properties made of wood, that is, wooden cultural properties, are becoming food for termites and are being damaged, which causes a significant social problem.

Looking at one case of Tongdosa Temple in Korea, it is reported that 5 out of 8 pillars in the Yaksa-jeon, each 50 cm in diameter and 3 meters tall, have already been severely damaged by termites, and that in one pillar, where the base has been gnawed, it is making a hollow sound up to the reachable part, and there is a hole large enough for a hand to fit between the stone foundation and the pillar.

In addition, it is reported that the Geungnakbojeon of Muwisa Temple in Jeollanam-do; the Daeungjeon of Seonunsa Temple in Jeollabuk-do; the Yeongsanjeon of Magoksa Temple in Chungcheongnam-do; the Daeungbojeon of Beopjusa Temple in Chungcheongbuk-do; the Geojoeom and Yeongsanjeon of Eunhaesa Temple, the Geungnakjeon and Imcheonggak of Bongjeongsa Temple, the Muryangsujeon of Gunja Jeong and the Josa-dang at Buseoksa Temple in Gyeongsangbuk-do; the Gyeoksa-mun, Haeunjeong, and Ojukheon in Gangwon-do are all damaged by termites.

According to the 2011 report by the National Research Institute of Cultural Heritage on the destruction of cultural properties by termites, out of 57 investigations on national treasures, treasures, and important folk cultural properties, 39 cases were reported to be damaged, with a damage rate of 68.4%.

The termites, which were known to inhabit only certain areas of the Korean Peninsula, such as Chungcheongnam-do and the western region in the 1920s, experienced a rapid increase in population due to rising temperatures on the Korean Peninsula as a result of global warming. Further, it has been confirmed through a 2004 survey that the termites are now evenly distributed across the whole country and the influx of invasive species is also increasing, and therefore, termite eradication is becoming a significant social issue.

As methods for termite eradication in wooden cultural properties, there are fumigation, wood preservatives, soil treatment, baiting, etc.

Among these methods, a baiting method attracts termites and causes them to feed on toxic substances along with the bait, so this method has the advantage of minimal contamination of the soil and human body due to the chemicals as an eradication method of destroying both individual termites and the colony.

The termite eradiation method using this baiting method is drawing attention due to its advantage of having little contamination of soil and the human body, and the above-mentioned baiting method is disclosed, as the prior art, in Korean Laid-open

However, the prior art disclosed in the above Korean Laid-open Patent Publication No. 1994-0006459 has the problem of being inefficient for termite detection, monitoring, or control, because bait stations with cartridges housed in the housing must be periodically separated for observation in order to investigate the activity of termites.

Further, existing termite capture or monitoring devices required the manager to periodically visit the site and check the devices in person, which imposed a heavy burden on time and manpower, and there were many problems in terms of efficiency, including cases where inspections were missed.

In addition, in the case of termite eradication baits, water-soluble baits are often used, and there was the problem that they could not perform their proper function due to loss when exposed to the outside.

Accordingly, there is a need for solving these problems.

### DISCLOSURE

### Technical Problem

The present disclosure has been devised in an effort to solve the problems in the related art described above, and has an object for ensuring that the presence or absence of termites and monitoring are accurately performed, and for enabling termite eradication using baits when termites are detected.

The objects of the present disclosure are not limited to the objects described above and other objects will be clearly understood by those skilled in the art from the following description.

### Technical Solution

In order to achieve the object described above, a trap with a selective bait exposure type termite eradication function of the present disclosure includes: a body that has an accommodation space formed therein and is configured to allow termites to enter and exit; a cover module that is coupled to an upper end of the body to prevent foreign substances from entering the body and simultaneously to prevent termites that have entered the body from freely escaping; and a cartridge module that is provided in the accommodation space, accommodates a bait capable of eradicating termites therein, and is at least partially opened to selectively expose the bait to the termites, wherein the cartridge module is provided with a separate feeding block, and when termites feed on the feeding block beyond a predetermined level, the cartridge module is opened and the bait is exposed to the outside.

Further, the cartridge module may include: a storage unit that accommodates the bait therein; and a trigger unit that includes the feeding block and adjusts opening and closing of the storage unit.

Further, the storage unit may include: a fixed part that has a predetermined area, has a seat space, and accommodates the bait; a moving part that is disposed at an upper end of the fixed part and seals the seat space while moving in a vertical direction; and an elastic restoring part that provides restoring force between the fixed part and the moving part and presses upward the moving part.

Further, the trigger unit may include a pair of rotary engagement parts that is bent with a predetermined length under the fixed part, of which a center is coupled to be rotatable in the vertical direction, and of which a upper end is fixed to and separated from the moving part depending on a rotation angle; the pair of rotary engagement parts may be disposed such that protruding ends may be disposed adjacent while facing each other, and the feeding block may be coupled between the ends; and when the feeding block is consumed, the rotary engagement parts may be rotated and the coupling state with the moving part may be released.

Further, the trigger unit may include: an expansion part that expands along a circumference of the fixed part and has a through-hole formed in the vertical direction; and an extension part that extends downward from a lower end of the moving part and is exposed downward through the through-hole, and the extension part may have a separate fixing groove, the feeding member may be mounted through the through-hole, and when the feeding member is consumed, the extension part may be moved upward.

Further, the trap may further include a detection module that includes a detection unit that can be linked with the cartridge module and determines whether the moving part ascends and descends on the basis of consumption of the feeding block caused by termites that have entered the body, and a communication unit that is provided in an upper case, receives a signal detected by the detection unit, and transmits the signal to an administrator server.

Further, the detection unit may include: a magnetic sensor that is provided in the cover module and can be linked with the communication unit; and a magnetic member that is provided at an upper end of the cartridge module and can be linked with the magnetic sensor, and the magnetic sensor may determine presence or absence of termites by detecting variation of a magnetic field depending on displacement of the magnetic member when the moving part ascends and descends, and may transmit a signal of influx of termites to the communication unit so that remote monitoring is performed by the administrator server.

Further, the trap may further include an attraction module that is disposed under the body, is made of a material containing cellulose, and serves to attract termites.

### Advantageous Effects

The trap with a selective bait exposure type termite eradication function of the present disclosure for achieving the object has following effects.

First, it is possible to prevent the bait from being consumed regardless of the presence or absence of termites, and to simultaneously perform both monitoring and eradication when termites appear.

Second, by suppressing the loss of the bait and minimizing the manager's access, there is an advantage that maintenance is facilitated and it is possible to suppress the movement of termites due to light exposure and odor.

The effects of the present disclosure are not limited to those described above and other effects not stated herein may be understood apparently to those skilled in the art from the claims.

### DESCRIPTION OF DRAWINGS

FIG. 1 is a perspective view illustrating the overall appearance of a trap with a selective bait exposure type termite eradication function according to an embodiment of the present disclosure;

FIG. 2 is a view illustrating the state in which the trap with a selective bait exposure type termite eradication function according to an embodiment of the present disclosure has been installed in the ground;

FIG. 3 is an exploded perspective view illustrating the detailed configuration of the trap with a selective bait exposure type termite eradication function according to an embodiment of the present disclosure;

FIG. 4 is a cross-sectional view illustrating the assembled appearance of the trap with a selective bait exposure type termite eradication function according to an embodiment of the present disclosure;

FIG. 5 is a view illustrating the configuration of a cartridge module in the trap with a selective bait exposure type termite eradication function according to an embodiment of the present disclosure;

FIG. 6 and FIG. 7 are views illustrating the state in which the cartridge module of FIG. 5 is operating;

FIG. 8 is a view illustrating a modified form of the cartridge module in the trap with a selective bait exposure type termite eradication function according to an embodiment of the present disclosure; and

FIG. 9 is a view illustrating the state in which the cartridge module of FIG. 8 is operating.

### BEST MODE

In the specification, when a component (or region, layer, part, etc.) is referred to as being “on,” “connected to,” or “coupled to” another component, it means that it may be directly placed/connected/coupled on the other component, or a third component may be placed between them.

The same reference numerals refer to the same components. Further, in the drawings, the thickness, proportions, and dimensions of components are exaggerated for the effective description of the technical content.

The term “and/or” includes all of one or more combinations that can be defined by associated components.

The terms used in the specification, “first”, “second”, etc., may be used to describe various components, but the components are not to be construed as being limited to the terms. The terms are used only to distinguish one component from another component. For example, the “first” component may be named the “second” component, and vice versa, without departing from the scope of the present disclosure. Singular forms are intended to include plural forms unless the context clearly indicates otherwise.

Further, the terms such as “below,” “lower,” “above,” and “upper” are used to describe the relationships of the components shown in the drawings. The above terms are relative concepts and are described on the basis of the directions shown in the drawings.

Unless otherwise defined, all terms used in the specification (including technical and scientific terms) have the same meaning as generally understood by those skilled in the art to which the present disclosure pertains. Further, the terms defined in commonly used dictionaries should be interpreted as having meanings consistent with the context of the relevant technology, and are explicitly defined here unless they are interpreted with idealistic or overly formal meanings.

It will be understood that the term “comprises” or “have” used in this specification specifies the presence of stated features, numerals, steps, operations, components, parts, or a combination thereof, but does not preclude the presence or addition of one or more other features, numerals, steps, operations, components, parts, or a combination thereof.

The present disclosure relates to a trap with a selective bait exposure type termite eradication function, which allows remote detection of the presence or absence of termites to enable a quick response without the need for a manager to visit the site in person. This trap with a selective bait exposure type termite eradication function is installed in the ground in multiple units at predetermined intervals around a building or structure made of wood that requires protection, to monitor the appearance of termites around the wooden building or structure in need of protection and to enable rapid eradication when detection occurs.

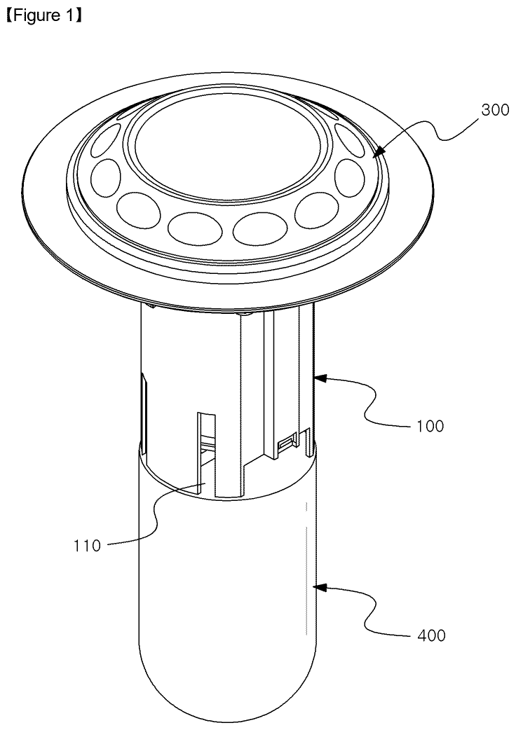

First, a trap with a selective bait exposure type termite eradication function according to the present disclosure is described with reference to FIG. 1 to FIG. 5.

A trap with a selective bait exposure type termite eradication function according to the present disclosure, as shown in the drawings, in a broad meaning, includes: a body 100 that has an accommodation space formed therein and is configured to allow termites to enter and exit; a cover module 300 that is coupled to the upper end of the body 100 to prevent foreign substances from entering the body 100 and simultaneously to prevent termites that have entered the body 100 from freely escaping; a cartridge module 200 that is provided in the accommodation space, accommodates a bait 10 capable of eradicating termites therein, and is at least partially opened to selectively expose the bait 10 to the termites; a detection module 500 that detects whether the cartridge module 200 is operating and detects the presence or absence of termites; and an attraction module 400 that is provided under the body 100 and attracts termites.

In detail, the body 100 forms the external appearance and a receiving space is formed therein to accommodate the cartridge module 200, and a separate passage hole 110 is formed to allow termites to penetrate into the interior when the body is buried underground.

In this case, it is preferable that the body 100 has an overall shape of a cylinder, but it is not limited thereto, and is configured in the shape of a polygonal column such as a triangular prism, a quadrangular prism, or a pentagonal prism, so as to be stably inserted and buried underground.

Further, the body 100 may be made of synthetic resin such as plastic or other various materials, which can prevent it from being lost or damaged.

Further, termites have a habit of creating tunnel-shaped tubes using their droppings or the like for protection and moving within them when they move through spaces or when the humidity is insufficient. Therefore, it is preferable that the passage hole 110 formed in the body 100 to allow termites to enter the body 100 is made in a circular hole shape to have a tube shape similar to a tunnel.

In this embodiment, the body 100 has a cylindrical shape with a certain length in the vertical direction, and has the attraction module 400, which will be described later, provided under it and the cover module 300 provided over it so that it can be buried underground.

Meanwhile, the attraction module 400 is additionally provided under the body 100 and is made of a material that attracts termites.

In detail, the attraction module 400 is preferably formed with a rounded shape or a needle-like shape at the lower end due to its characteristic of being buried underground, and is preferably made of a material containing cellulose, such as wood, to be more effective in luring termites.

In this case, the attraction module 400 may be configured to be detachably connected with the body 100, and a separate hole may be formed inside it to communicate with the interior of the accommodation space.

Meanwhile, the cover module 300 can be detachably connected to the upper end of the body 100 by various methods, such as fitting, fastening, or hinging, or any method that allows the upper end of the body 100 to be opened, and this is for preventing foreign substances from entering the body 100, preventing termites that have entered the body 100 from freely escaping, as well as for making the replacement and maintenance of the cartridge module 200 and the detection unit 510, which are accommodated in the body 100, easy to perform.

The cover module 300 may simply be formed as a plate-shaped structure that can cover the upper end of the body 100, but it is not limited thereto and is preferably formed into a structure that creates an internal space that can prevent the termites that have entered the body 100 from affecting the communication unit 520 and the detection unit 510 while moving and can accommodate the communication unit 520 and the detection unit 510 so that they are protected from external forces.

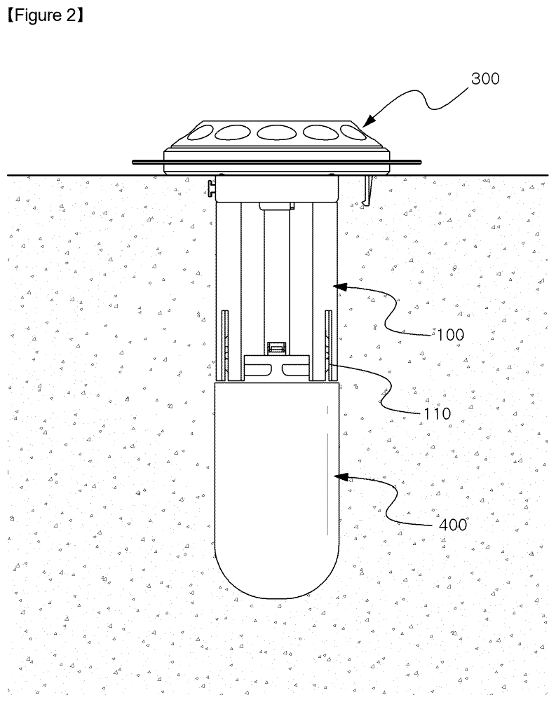

In this embodiment, as shown in FIG. 2, the cover module 300 may be positioned on the ground surface when the body 100 is inserted into the ground and can be exposed, and a portion of the cover module 300 may be configured to be openable and closable so that it is easy to replace or inspect the detection module 500. Further, the cover module 300 is equipped with a PCB board or a battery inside, so it provides power for the operation of the detection module 500 and controls them.

Additionally, the cover module 300 is equipped with a separate carbon dioxide emission unit (not illustrated) at the outside, which can extend the attraction range for termites.

In detail, the carbon dioxide emission unit is provided to be detachable from the inside or outside of the cover module 300 and is formed in the shape of a chamber and configured to release the carbon dioxide stored inside into the surrounding area.

In this case, termites have the tendency to gather in places with a high concentration of carbon dioxide, and through this, the carbon dioxide can be emitted over a wider range to attract termites.

The accommodation space is provided with a bait 10 capable of eradicating termites, and is at least partially selectively opened to expose the bait 10 to termites.

In detail, the cartridge module 200 is disposed in a sealed state with the bait 10 enclosed inside, but a separate feeding block 224 is configured to open when its shape is damaged beyond a predetermined level by feeding of termites so that the termites can feed on the bait 10.

The cartridge module 200 can be linked with the detection module 500 and includes the feeding block 224 that is the food of termites that has entered inside through the passage hole 110 formed in the body 100, thereby opening the bait 10 by being opened by the action of feeding activity of the termites, and at the same time, serving to enable the detection module 500 to check and detect the presence or absence of termites.

The feeding block 224 serves as bait to allow feeding when termites enter, while also functioning as a trigger in the cartridge module 200, and materials such as wood, pulp, or Hanji may be used.

In this case, the feeding block 224 is preferably not deformed by external conditions or temperature and humidity, and it is preferable that pulp or Hanji with a predetermined level of tensile strength in the longitudinal direction is used. Accordingly, the feeding block 224 is relatively less affected by external influences other than the feeding activity of termites and can maintain its initial form.

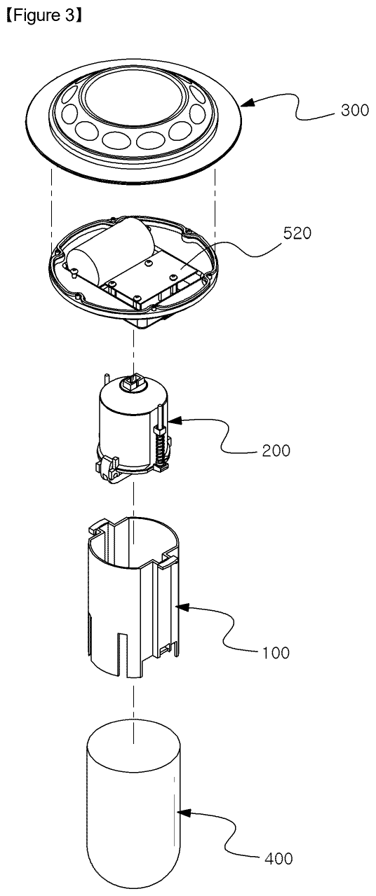

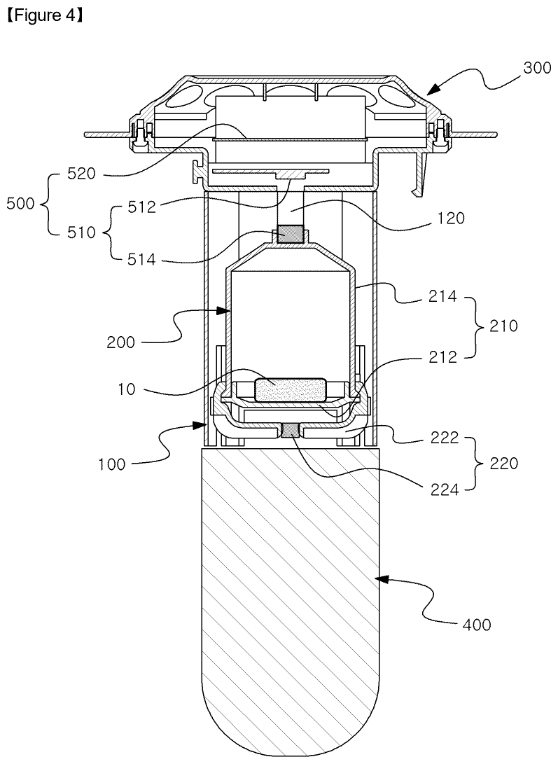

In this embodiment, the cartridge module 200, as illustrated in FIG. 3 and FIG. 4, can be seated in the accommodation space inside the body 100, and is formed in the shape of a separate sealed case, so when the feeding block 224 is deformed or consumed, a portion of the cartridge module moves upward, and accordingly, the bait 10 is exposed to termites.

In this case, the bait 10 is a chemical agent that can be eaten by termites through feeding activity, and is made of a material that acts as a poison to termites when fed on, thereby enabling their eradication.

Further, it is preferable that other components other than the bait 10 and the feeding block 224 in the cartridge module 200 are made of a material that does not contain cellulose so that they are not recognized as food by termites, thereby preventing any disruption to the operation.

In this embodiment, the cartridge module 200, when described in more detail, generally includes a storage unit 210 and a trigger unit 220. The storage unit 210 has a space of a certain size inside and accommodates the bait 10 to be isolated from the outside, and is selectively opened by the trigger unit 220 to be able to expose the bait 10 to the outside. In this case, the bait 10 can be protected within the storage unit 210 from impurities entering from the outside or environmental changes, thereby preventing unintended loss.

In detail, the storage unit 210 includes a fixed part 212 that has a predetermined area and forms a seat space to accommodate the bait 10, a moving part 214 that is disposed at the upper end of the fixed part 212 and seals the seat space by moving in the vertical direction, and an elastic restoring part 216 that provides restoring force between the fixed part 212 and the moving part 214 and presses the moving part 214 upward.

The fixed part 212 is formed in the shape of a plate having a predetermined circumference, and the bait 10 is seated at the center of the upper surface. In this case, the bait 10 is on the seat recessed at the center of the upper surface of the fixed part 212.

The fixed part 122 configured as described above is disposed in a fixed state with the body 100 in the accommodation space.

In this embodiment, the fixed part 212 is fixed by a guide frame 120, which is elongated in the vertical direction inside the body 100, and the elastic restoring part 216 to be described below may be provided inside the guide frame 120.

The moving part 214 is provided over the fixed part 212 and is configured to move in the vertical direction with a predetermined length.

In this embodiment, as illustrated, the moving part 214 is formed in a cylindrical shape with an open bottom, is disposed over the seat, and is moved downward to surround the bait 10 together with the fixed part 212, thereby preventing external exposure.

Further, at least one or more elastic restoring parts 216 are disposed circumferentially on the fixed part 212 and are arranged in the vertical direction. In this case, the elastic restoring part 216 has a separate shaft 216a elongated in the vertical direction on the fixed part 212, and the shaft 216a is coupled through a flange 214a protruding from the moving part 214.

Further, an elastic member is disposed between the moving part 214 and the fixed part 212 while surrounding the circumference of the shaft 216a so that restoring force acts upward on the moving part 214.

Accordingly, the moving part 214 moves stably without detaching when it is moved in the vertical direction with the elastic restoring part 216 penetrating the flange 214a.

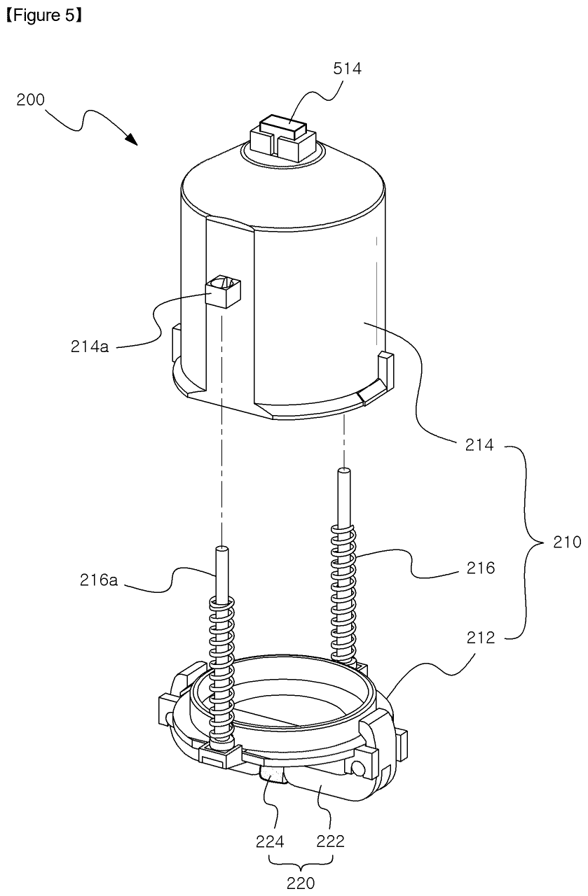

As described above, the storage unit 210 according to the present disclosure, as shown in FIG. 5, includes the fixed part 212, the moving part 214, and the elastic restoring part 216, and the moving part 214 can expose the bait 10 to the outside by selectively moving up and down when fixed or released by the trigger unit 220 to be described below.

Meanwhile, the trigger unit 220 includes a pair of rotary engagement parts 222 that is bent with a predetermined length under the fixed part 212, of which the center is coupled to be rotatable in the vertical direction, and of which the upper end is fixed to and separated from the moving part 214 depending on the rotation angle.

In detail, a plurality of rotary engagement parts 222 are provided as shown, and each is formed in an ‘L’ shape or a ‘L’ shape, and is rotatably coupled to the edge along the circumference of the fixed part 212.

In this case, the rotary engagement parts 222 are configured to be rotatable in the vertical direction on the fixed part, and are coupled such that restoring force acts downward. Further, the upper end is formed in a hook shape to be engaged on the lower end of the moving part 214.

That is, the plurality of rotary engagement parts 222 are spaced apart along the circumference of the fixed part 212, and when they rotate upward, the end portion of each engages with the edge along the circumference of the moving part 214, thereby preventing the moving part 214 from moving upward. In this case, it is preferable that the lower end of the moving part 214 is extended along its circumference so that the upper end of the rotary engagement parts 222 can be caught.

In this embodiment, the rotary engagement parts 222 are configured as a pair and arranged to face each other, and the ends protruding from the lower portion of the fixed part 212 is disposed adjacent and facing each other, so the feeding block 224 is coupled between them.

Accordingly, the rotary engagement parts 222 are supported by the feeding block 224 and are fixed in a state rotated upward, thereby preventing the moving part 214 from moving upward.

Further, when the feeding block 224 is consumed due to termites that have entered, the rotary engagement parts 222 are rotated, and the engaged state with the moving part 214 is released, thereby allowing the moving part 214 to move upward.

As described above, the trigger unit 220 includes the rotary engagement parts 222 and the feeding block 224, and when the rotary engagement parts 222 are supported by the feeding block 224, they engage with the moving part 214 to prevent it from moving upward, but when the feeding block 224 is consumed, the moving part 214 moves upward.

As described above, the cartridge module 200 according to the present disclosure includes the storage unit 210 and the trigger unit 220, and when the feeding block 224 is consumed or deformed due to the influx of termites, the storage unit 210 is opened and the bait 10 is exposed to the outside.

Meanwhile, the detection module 500 is configured to detect the influx of termites into the body 100 and transmit the detection result to the outside, includes a detection unit 510 that can be linked with the cartridge module 200 and determines whether the moving part 214 ascends or descends on the basis of the consumption of the feeding block 224 caused by the termites that have entered the body 100, and a communication unit 520 that is provided in the upper case, and receives the signal detected by the detection unit 510 and transmit it to an administrator server.

In detail, the detection unit 510 may be provided inside the cover module 300, and may include a magnetic sensor 512 that can be linked with the communication unit 520, and a magnet member 514 that is provided at a side of the moving part 214 and can be linked with the magnetic sensor 512.

In this case, the magnet member 514 is moved together with the moving part 214 when the moving part 214 is moved upward, and the magnetic sensor 512 detects this and determines the operation status of the moving part 214.

Accordingly, the detection unit 510 can determine that termites have entered the body 100. In this case, the magnetic sensor 512 is configured to be linkable with the communication unit 520 so that the information on the influx of termites detected and determined by the detection unit 510 is signalized and transmitted to the administrator server through the communication unit 520. Therefore, a manager can detect the presence or absence of termites remotely through the administrator server without the need for periodic site visits and inspect each one directly.

In this case, the magnet member 514 is moved together with the movable part 214 when the movable part 214 is moved upward, and the magnetic sensor 512 detects it.

Accordingly, the detection unit 510 can determine that termites have entered the body 100. In this case, the magnetic sensor 512 is configured to be linkable with the communication unit 520 so that the information on the influx of termites detected and determined by the detection unit 510 is signalized and transmitted to the administrator server through the communication unit 520. Therefore, a manager can detect the presence or absence of termites remotely through the administrator server without the need for periodic site visits and inspect each one directly.

As described above, according to the trap of the present disclosure, when termites that have entered the body 100 feed on the feed member 224 and cause deformation or damage beyond a predetermined level, the bait 10 is opened, and at the same time, the presence or absence of termites is transmitted to the administrator server through the detection module 500.

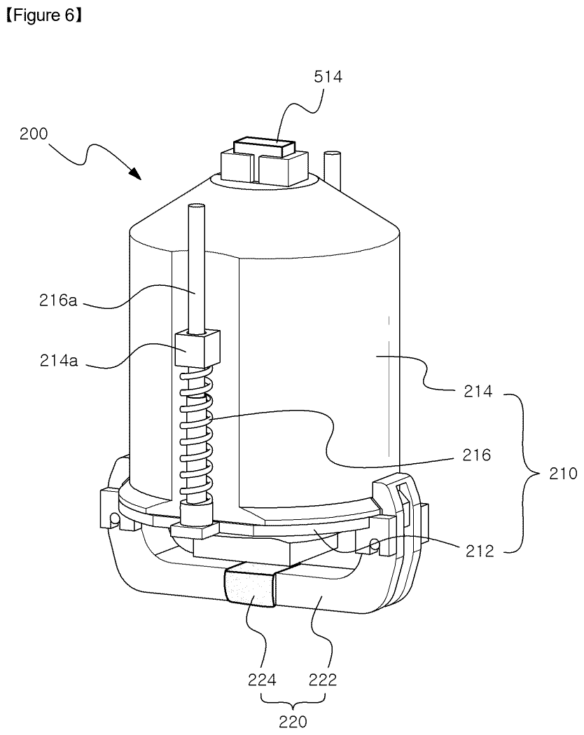

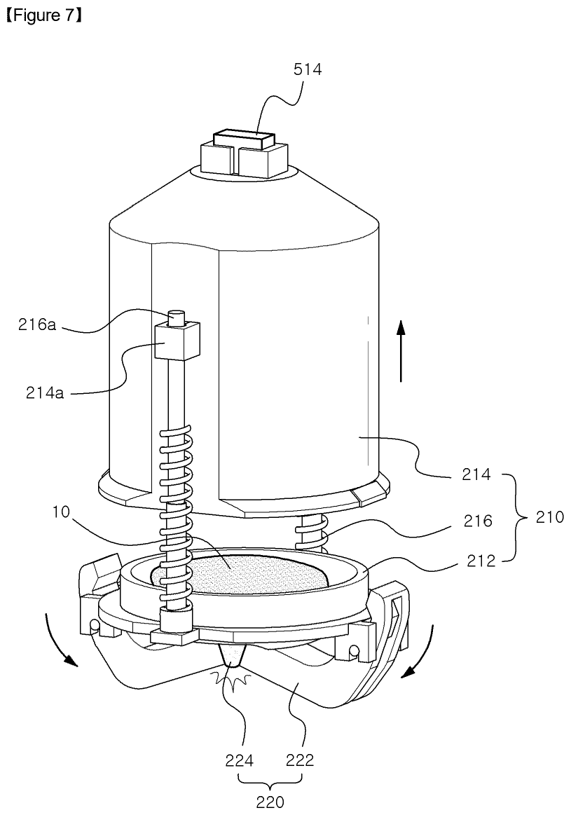

Next, the state in which storage unit 210 according to the present disclosure is operated is described with reference to FIG. 6 and FIG. 7.

First, referring to FIG. 6, the moving part 214 is moved downward, and in this state, it is fixed by the trigger unit 220. In this case, with respect to the fixed part 212, the pair of rotary engagement parts 222 have been rotated upward while facing each other and their lower ends are spaced a predetermined gap apart from each other.

Further, the feeding block 224 is seated between the lower ends of the rotary engagement parts 222, thereby supporting the rotary engagement parts 222 to prevent them from rotating downward.

Thereafter, when termites enter the body 100 and the feeding block 224 is consumed or deformed beyond a predetermined level, as shown in FIG. 7, the rotary engagement parts 222 are rotated downward.

Further, in conjunction with this, the locking state of the moving part 214 is released, and it is moved upward along the elastic restoring part 216.

In this case, the magnet member 514 is provided on the upper part of the moving part 214 and is moved upward together, and this is detected by the magnetic sensor 512, so the operation status of the moving part 214 is transmitted to the communication unit 520.

Through this process, the trap according to the present disclosure allows the entry of termites into the body 100, and by checking the consumption of the feeding block 224, it opens the storage unit 210 to eradicate the termites while simultaneously using the detection module 500 to transmit the occurrence of termites to the administrator server for monitoring.

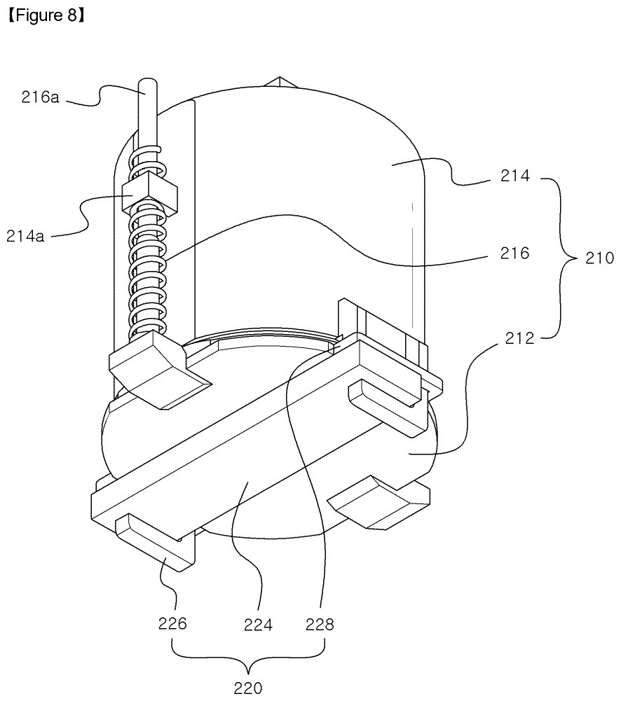

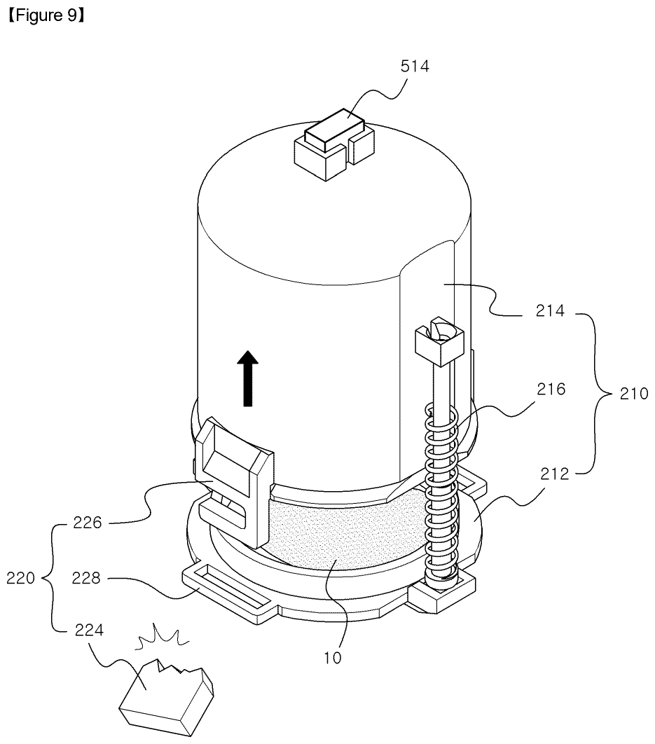

Next, a modified form of the cartridge unit in the trap according to the present disclosure is described as follows with reference to FIG. 8 and FIG. 9.

FIG. 8 is a view illustrating a modified form of the cartridge module 200 in the trap with a selective bait exposure type termite eradication function according to an embodiment of the present disclosure and FIG. 9 is a view illustrating the state in which the cartridge module 200 of FIG. 8 is operating.

Referring to the figures, the form in which a portion of the storage unit 210 in the cartridge module 200 is moved upward to expose the bait 10, as in the embodiment described above, is similar, but the configuration of the trigger unit 220 is different.

In detail, referring to a view shown in FIG. 8, the storage unit 210 includes the fixed unit 212, the moving unit 214, and the elastic restoring unit 216.

However, the trigger unit 220 includes an expansion part 228 expanding along the circumference of the fixed part 212 and having a through-hole formed in the vertical direction, and an extension part 226 formed to extend downward from the lower end of the moving part 214 and exposed downward through the through-hole. The extension part 226 has a separate fixing groove, and the feeding block 224 is mounted through the through-hole, and when the feeding block 224 is consumed, the extension part 226 is moved upward.

In this case, at least one or more expansion parts 228 are formed in a shape protruding along the circumference of the fixed part 212, and each part has a through-hole. Further, the extension part 226 extends downward from the lowest end of the moving part 214 at a position corresponding to the through-hole, and passes through the through-hole.

In this case, the extension part 226 is coupled with the feeding block 224 under the fixed part 212 while passing through the through-hole, and is fixed by the feeding block 224.

Referring to the figures, the extension part 226 is formed with a separate fixing groove where the feeding block 224 is inserted and fixed, so that the feeding block 224 is seated. The feeding block 224 is formed in a long bar shape and is formed to have a relatively larger area than the through-hole.

Accordingly, as shown in FIG. 8, the moving part 214 is moved downward, the extension part 226 passes through the through-hole, and in this state, the feeding block 224 is fastened, so it is possible to maintain the state in which the fixed part 212 and the moving part 214 shield the bait 10 such that the bait 10 is not exposed to the outside.

Next, as shown in FIG. 9, when the feeding block 224 is consumed by termites and is deformed or damaged, the moving part 214 is moved upward due to the restoring force of the elastic restoring part 216, and the bait 10 is exposed to the outside.

Through the trap with a selective bait exposure type termite eradication function which has the structure described above, it is possible to eradicate termites using the bait 10 when the termites enter the trap, and simultaneously, a manager who remotely detects this can identify the presence of the termites.

Further, it is possible to prevent the bait 10 from being consumed regardless of the presence or absence of termites, and to simultaneously perform both monitoring and eradication when termites appear.

Further, by suppressing the consumption of the bait 10 and minimizing the manager's access, there is an advantage that maintenance is facilitated and it is possible to suppress the movement of termites due to light exposure and odor.

Although preferred embodiments of the present disclose were described above, it would be apparent to those skilled in the art that the present disclosure may be embodied in other specific types without departing from the purport or scope other than the embodiment described above. Accordingly, the embodiment described above should be considered as being exemplifying rather than limiting, so the present disclosure may be changed within the range of the claims and the equivalent range without being limited to the above description.

The present disclosure was carried out as part of the Cultural Heritage Smart Preservation and Utilization Technology Development Project by the Cultural Heritage Administration of Korea and the National Research Institute of Cultural Heritage of Korea (Project title: Exploration of termite activity detection biomarkers and development of a smart monitoring system, Project number: RS-2021-NC100803).

### DESCRIPTION OF THE REFERENCE NUMBER

100: body
200: cartridge module
210: storage unit
220: trigger unit
300: cover module
400: attraction module
500: detection module
510: detection unit
520: communication unit
10: bait

1. A trap with a selective bait exposure type termite eradication function, the trap comprising:
a body that has an accommodation space formed therein and is configured to allow termites to enter and exit;
a cover module that is coupled to an upper end of the body to prevent foreign substances from entering the body and simultaneously to prevent termites that have entered the body from freely escaping; and
a cartridge module that is provided in the accommodation space, accommodates a bait capable of eradicating termites therein, and is at least partially opened to selectively expose the bait to the termites,
wherein the cartridge module is provided with a separate feeding block, and when termites feed on the feeding block beyond a predetermined level, the cartridge module is opened and the bait is exposed to the outside.

2. The trap of claim 1, wherein the cartridge module includes:
a storage unit that accommodates the bait therein; and
a trigger unit that includes the feeding block and adjusts opening and closing of the storage unit.

3. The trap of claim 2, wherein the storage unit includes:
a fixed part that has a predetermined area, has a seat space, and accommodates the bait;
a moving part that is disposed at an upper end of the fixed part and seals the seat space while moving in a vertical direction; and
an elastic restoring part that provides restoring force between the fixed part and the moving part and presses upward the moving part.

4. The trap of claim 3, wherein the trigger unit includes a pair of rotary engagement parts that is bent with a predetermined length under the fixed part, of which a center is coupled to be rotatable in the vertical direction, and of which an upper end is fixed to and separated from the moving part depending on a rotation angle;
the pair of rotary engagement parts is disposed such that protruding ends are disposed adjacent while facing each other, and the feeding block is coupled between the ends; and
when the feeding block is consumed, the rotary engagement parts are rotated and the moving part is moved upward.

5. The trap of claim 3, wherein the trigger unit include:
an expansion part that expands along a circumference of the fixed part and has a through-hole formed in the vertical direction; and
an extension part that extends downward from a lower end of the moving part and is exposed downward through the through-hole, and
the extension part has a separate fixing groove, the feeding member is mounted through the through-hole, and when the feeding member is consumed, the extension part is moved upward.

6. The trap of claim 3, further comprising a detection module that includes a detection unit that can be linked with the cartridge module and determines whether the moving part ascends or not on the basis of consumption of the feeding block caused by termites that have entered the body, and a communication unit that is provided in an upper case, receives a signal detected by the detection unit, and transmit the signal to an administrator server.

7. The trap of claim 6, wherein the detection unit includes:
a magnetic sensor that is provided in the cover module and can be linked with the communication unit; and
a magnetic member that is provided at an upper end of the cartridge module and can be linked with the magnetic sensor,
wherein the magnetic sensor determines presence or absence of termites by sensing variation of a magnetic field depending on displacement of the magnetic member when the moving part ascends and descends, and transmits a signal of influx of termites to the communication unit so that remote monitoring is performed by the administrator server.

8. The trap of claim 1, further comprising an attraction module that is disposed under the body, is made of a material containing cellulose, and serves to attract termites.
